(19) United States
(12) Patent Application Publication
(10) Pub. No.: US 2024/0072329 A1
(43) Pub. Date: Feb. 29, 2024

(54) BATTERY MODULE WITH IMPROVED COOLING PERFORMANCE AND METHOD FOR PREPARING THE SAME

(71) Applicant: SK On Co., Ltd., Seoul (KR)

(72) Inventors: Ji Hoon LIM, Daejeon (KR); Myeong Hwan MA, Daejeon (KR); Ju Yong PARK, Daejeon (KR)

(21) Appl. No.: 18/451,839

(22) Filed: Aug. 18, 2023

(30) Foreign Application Priority Data
Aug. 23, 2022 (KR) 10-2022-0105498

(51) Int. Cl. H01M 10/653; H01M 10/613; H01M 50/211; H01M 50/222; H01M 50/227; H01M 50/229; H01M 50/231; H01M 50/233

(52) U.S. Cl. CPC H01M 10/653; H01M 10/613; H01M 50/211; H01M 50/222; H01M 50/227; H01M 50/229; H01M 50/231; H01M 50/233

(57) ABSTRACT

A battery module including at least one battery cell; a module case in which the at least one battery cell is accommodated, and including a lower plate and a side plate forming an internal space; and a thermally conductive coating layer formed on an internal surface of the lower plate or an internal surface of the lower plate and an internal surface of the side plate, and having a thickness of 70 μm to 130 μm, wherein the thermally conductive coating layer includes a polymeric binder resin and an inorganic filler, is disclosed.

### CROSS-REFERENCE TO RELATED APPLICATION(S)

This patent document claims the priority and benefits of Korean Patent Application No. 10-2022-0105498 filed on Aug. 23, 2022, the disclosure of which is incorporated herein by reference in its entirety.

### TECHNICAL FIELD

The technology and implementations disclosed in this patent document generally relate to a battery module having improved cooling performance and a method for preparing the same.

### BACKGROUND

Secondary batteries capable of charging and discharging electricity are being actively researched according to the development of devices within high-tech fields such as a digital camera, a smartphone, a notebook, a hybrid vehicle, or the like. Secondary batteries include a nickel-cadmium battery, a nickel-metal hydride battery, a nickel-hydrogen battery, a lithium secondary battery, and the like. Thereamong, the lithium secondary battery may have an operating voltage of 3.6V or more, and may be used as a power source for portable electronic devices, or may be used for a high-power hybrid vehicle by connecting a plurality of the lithium secondary battery in series. Since the lithium secondary battery may have an operating voltage about three times higher than an operating voltage of the nickel-cadmium battery or the nickel-metal hydride battery, and may have an excellent energy density per unit weight, usage thereof is rapidly increasing.

When the plurality of secondary batteries are connected in series and are used in a high-power hybrid vehicle or a high-power electric vehicle, one or more secondary batteries may be fixed using a member such as a cover, a case, or the like, and the fixed one or more secondary batteries may be electrically connected to each other using a connecting member such as a bus bar or the like, to be used as a single battery module.

In general, an insulating painting operation may be performed in an internal space of a battery module, to prevent occurrence of electricity between a battery cell and a module case, or to prevent occurrence of corrosion. In addition, a method of securing insulation performance by using aluminum as a module case material and anodizing the aluminum to improve cooling performance, may be also used.

Meanwhile, a painting operation for securing insulation may be performed in a region in which the battery cell and the module case are in direct contact with each other, but the painting operation for insulation between the battery cell and the module case may generally interfere with cooling, and accordingly, lifespan of the battery may be deteriorated or cooling efficiency of the battery may be lowered, to cause occurrence of problems in performance of the battery.

### SUMMARY

The disclosure of this patent document is to solve the above problems, and the disclosed technology may be implemented in some embodiments to provide a battery module having excellent cooling performance as well as excellent insulation, and a method for preparing the same.

In some embodiments of the disclosed technology, a battery module includes at least one battery cell; a module case in which the at least one battery cell is accommodated, and including a lower plate and a side plate forming an internal space; and a thermally conductive coating layer formed on an internal surface of the lower plate or an internal surface of the lower plate and an internal surface of the side plate, and having a thickness of 70 μm to 130 μm, wherein the thermally conductive coating layer includes a polymeric binder resin and an inorganic filler.

The thermally conductive coating layer may include 20 to 50% by weight of the inorganic filler, based on a total weight of the thermally conductive coating layer.

The thermally conductive coating layer may have a thermal conductivity of 200 W/mK or more and 230 W/mK or less.

The thermally conductive coating layer may have a withstand voltage intensity of 2.5 to 4.0 kV.

Adhesive strength between the thermally conductive coating layer and the battery cell may be 500 to 2000 gf/10 mm.

The polymeric binder resin may include at least one selected from the group consisting of an acrylic resin, a urethane-based resin, a silicone-based resin, an epoxy-based resin, and an olefin-based resin.

The inorganic filler may include at least one ceramic particle selected from the group consisting of alumina, aluminum nitride, boron nitride, silicon nitride, SiC, silica, ZnO, and BeO.

The thermally conductive coating layer may further include a carbon-based filler.

The thermally conductive coating layer may have a surface roughness Ra of 0.7 μm or more and 50 μm or less.

In some embodiments of the disclosed technology, a method of preparing a battery module, includes applying a coating composition to an internal surface of a module case including a lower plate and a side plate forming an internal space; curing the coating composition to form a coating layer having a thickness of 70 μm to 130 μm; and accommodating at least one battery cell in the module case on which the coating layer is formed.

### BRIEF DESCRIPTION OF DRAWINGS

Certain aspects, features, and advantages of the disclosed technology may be illustrated by the following detailed description with reference to the accompanying drawings.

FIG. 1 schematically illustrates a battery module according to an embodiment of the disclosure of this patent document.

FIG. 2 is a graph illustrating relationships between a thickness of a resin layer, thermal conductivity, and withstand voltage performance.

### DETAILED DESCRIPTION

Hereinafter, preferred embodiments of the disclosure of this patent document will be described with reference to various examples. However, the embodiments of the disclosure of this patent document may be modified in many different forms, and the scope of the disclosure of this patent document is not limited to the embodiments described below.

The disclosure of this patent document relates to a battery module having improved cooling performance and a method for preparing the same.

According to one aspect of the disclosure of this patent document, a battery module including at least one battery cell; a module case in which the at least one battery cell is accommodated, and including a lower plate and a side plate forming an internal space; and a coating layer formed on an internal surface of the module case, and having a thickness of 70 μm to 130 μm, wherein the coating layer includes a polymeric binder resin and an inorganic filler, is disclosed.

A battery cell may be accommodated in the module case. The battery cell may be provided as one or more battery cells in the module case, and the battery cells stored in the module case may be electrically connected to each other. The number of battery cells accommodated in the module case may be adjusted according to use thereof or the like, but is not particularly limited thereto.

The module case may include the side plate and the lower plate, forming the internal space in which the battery cells are accommodated. In addition, the module case may further include an upper cover for sealing the internal space. A shape and a size of the module case are not particularly limited, and may be appropriately selected depending on use thereof, shapes and the number of battery cells accommodated in the internal space, or the like.

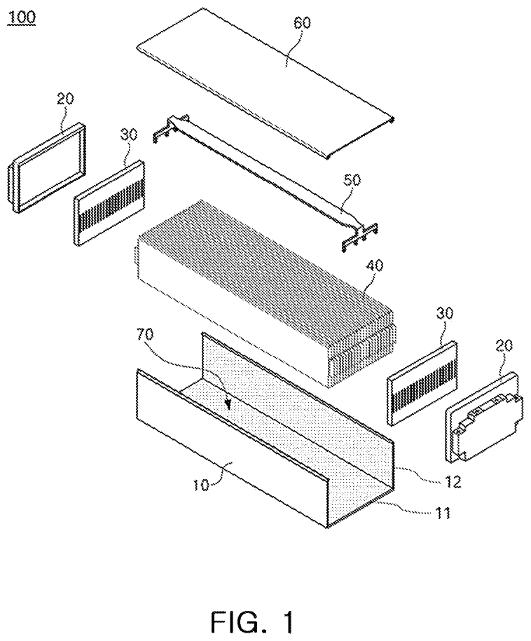

For example, as illustrated in FIG. 1, a module case may be a structure that surrounds a lower side and both sides of a battery cell, or an upper side and both sides of the battery cell, and may be integrally formed to have a ‘⊂’ shape. The module case may be formed by assembling a separate side plate, a separate lower plate, and/or a separate upper plate, or may be formed to have a configuration in which a side plate, a lower plate, and an upper plate are integrated.

The module case may perform functions of supporting and protecting the battery cell, and, may perform, at the same time, functions of cooling the battery cell by water-cooling or air-cooling to protect the secondary battery from heat generated therefrom during charging and discharging electricity of the battery module and from heat generated therefrom according to a change in an external temperature, an external pressure, or the like, and of maintaining the temperature on an appropriate level.

Therefore, the module case may be formed of a material having excellent thermal conductivity, and although not particularly limited, a metal material such as aluminum, gold, pure silver, tungsten, copper, nickel, or platinum may be used. Specifically, aluminum may be used.

According to an embodiment of the disclosure of this patent document, a thermally conductive coating layer may be formed on an internal surface of a module case in which a battery cell is accommodated. The thermally conductive coating layer may cover a foreign substance existing on a surface of the module case, to prevent occurrence of a side effect that may be generated due to the foreign substance. Specifically, the thermally conductive coating layer may provide insulation to the internal surface of the module case, to prevent occurrence of static electricity, and, furthermore, may contribute to removing dust.

The thermally conductive coating layer may not only provide the functions mentioned above, may but also improve cooling efficiency by forming surface roughness on the internal surface of the module case to increase a contact area with the battery cell accommodated therein. To improve the cooling efficiency as described above, the thermally conductive coating layer may be formed in the module case. More specifically, the thermally conductive coating layer may be formed on a lower plate of the module case or on a lower plate and a side plate of the module case. In this manner, heat generated from the battery cell accommodated therein may be more effectively cooled by contacting the battery cell with the thermally conductive coating layer on an internal surface of the lower plate of the module case or an internal surface of the lower plate and an internal surface of the side plates of the module case.

The thermally conductive coating layer may have a surface roughness Ra of 0.7 μm or more, as measured by ISO 1302:1992, to improve cooling efficiency according to an increase in contact area with the battery cell. When the surface roughness of the thermally conductive coating layer is less than 0.7 μm, an effect of increasing the contact area with the battery cell may be small. Therefore, it may be difficult to obtain an effect of improving cooling efficiency. When the surface roughness of the thermally conductive coating layer is too high, a surface of a pouch cell accommodated therein may be rather damaged. For example, the thermally conductive coating layer may have a surface roughness of 50 μm or less.

The thermally conductive coating layer may have a thickness of 50 to 500 μm in terms of simultaneously securing insulation performance and cooling performance, but is not limited thereto. For example, the thickness of the thermally conductive coating layer may be 50 μm or more, 70 μm or more, 80 μm or more, or 100 μm or more, and may be 300 μm or less, 250 μm or less, 200 μm or less, 150 μm or less, or 130 μm or less. When the thickness of the thermally conductive coating layer is less than 50 μm, insulation performance or withstand voltage performance may be deteriorated, and when the thickness exceeds 500 μm, cooling performance may be deteriorated. More specifically, the thermally conductive coating layer may have a thickness of 70 to 130 μm.

The thermally conductive coating layer may have thermal conductivity of 200 W/mK or more in terms of improving cooling efficiency by contact with the battery cell. For example, the thermal conductive coating layer may have a thermal conductivity of 200 W/mK or more and 240 W/mK or less, and more specifically, greater than 200 W/mK and less than 230 W/mK.

When the thermal conductivity of the thermal conductive coating layer is less than 200 W/mK, cooling efficiency of the battery cell may not be sufficient, which may cause occurrence of a temperature deviation between battery cells, and a local increase in temperature of the module may adversely affect the lifespan or safety of the battery module. When the thermal conductivity of the thermal conductive coating layer exceeds 240 W/Mk, and thermal runaway of the battery cell occurs, thermal diffusion may excessively increase to cause an increase in temperature of an adjacent battery cell or another adjacent module and to cause occurrence of a large fire.

The thermally conductive coating layer of the disclosure of this patent document may have a withstand voltage intensity of 2.5 kV or more and 4.0 kV or less. The withstand voltage intensity may be an intensity indicating a degree of pressure that may be endured without being damaged when a voltage is applied to the battery module.

Since the thermally conductive coating layer has the withstand voltage intensity in the above range, insulation performance and cooling performance may be secured, and durability may be secured at the same time.

As described above, the thermal conductive coating layer of the disclosure of this patent document may also increase a contact area with the battery cell to improve an adhesive force between the coating layer and the battery cell. Therefore, according to an embodiment of the disclosure of this patent document, an adhesive force between the thermally conductive coating layer and the battery cell may be 500 to 2000 gf/10 mm.

The thermally conductive coating layer may include a polymeric binder resin and a thermally conductive filler and/or an insulating filler.

The polymeric binder resin may be provided as a matrix of the thermally conductive coating layer, and is not particularly limited, but a general thermoplastic resin may be used, such as at least one selected from the group consisting of an acrylic resin, a urethane-based resin, a silicone-based resin, an epoxy-based resin, and an olefin-based resin may be used. In addition, a resin having thermal conductivity may be used.

The polymeric binder resin may be included in an amount of 50 to 75% by weight. When an amount of the polymeric binder resin is less than 50% by weight, it may not be easy to form a coating layer because an amount of the resin provided as a matrix is low. When an amount of the polymeric binder resin exceeds 75% by weight, an amount of the filler, in particular, an amount of an inorganic material that provide thermal conductivity, may be relatively reduced, it may be difficult to secure thermal conductivity.

The thermally conductive coating layer may include a filler that further improves thermal conductivity or secures electrical insulation. The filler is not particularly limited, but may be an inorganic filler, and more specifically, the inorganic filler may be one or more ceramic particles selected from the group consisting of alumina, aluminum nitride, boron nitride, silicon nitride, SiC, silica, ZnO, and BeO in consideration of insulation, and any one of the ceramic fillers may be used alone, or two or more of the ceramic fillers may be mixed and used.

The filler is not particularly limited, but may be included in an amount of 20 to 50% by weight. When an amount of the filler is less than 20% by weight, an effect of improving thermal conductivity or electrical insulation may be small. When an amount of the filler exceeds 50% by weight, an additional effect may not increase due to an increase in amount to be added, and formation of the thermally conductive coating layer may be deteriorated.

Furthermore, the thermally conductive coating layer may also use a carbon-based filler such as graphite, carbon black, or the like, when an insulating property is sufficiently secured. The carbon-based filler is not particularly limited, but may be included in an amount of 10% by weight or less.

Furthermore, the thermally conductive coating layer of the disclosure of this patent document may further include an additive, commonly used, as needed.

The disclosure of this patent document also provides a method of preparing a battery module having the thermally conductive coating layer formed thereon. The method may include applying a coating composition to an internal surface of a module case including a lower plate and a side plate forming an internal space; curing the coating composition to form a coating layer having a thickness of 70 μm to 130 μm; and accommodating a plurality of battery cells in the module case on which the coating layer is formed.

A method of controlling the thermally conductive coating layer to have a surface roughness of a predetermined value may not be particularly limited, and a method of controlling a surface roughness to be commonly used may be applied. For example, the surface roughness may be controlled by a particle diameter of the inorganic filler to be used, and the surface roughness may increase as a particle size of the inorganic filler increases. Therefore, in the disclosure of this patent document, to provide the above surface roughness, an inorganic filler having an average particle size of 30 to 50 μm may be used.

The thermally conductive coating layer is not particularly limited, but a conventional method used for forming a coating layer on a surface of a substrate may be applied. For example, various processes such as a spray coating process, a process using a doctor blade, a powder coating process, a spin coating process, a tape casting process, a slot die coating process, a gravure coating process, an offset coating process, or the like may be formed. More specifically, the coating layer may be formed by the powder coating process.

In forming the thermally conductive coating layer by the powder coating process, the thermally conductive coating layer may be prepared by spraying a powder coating material including the polymeric binder resin, the filler, and the carbon-based filler, as necessary, described above, on the internal surface of the module case, to form a coating layer, and baking and drying the coating layer.

In this case, a temperature of the module case is not particularly limited, but may be 50° C. or less, and when the powder coating material is sprayed, powder coating of the module case may be performed in a state in which a voltage of 60 to 80 kV is applied.

After the powder coating is performed on the internal surface of the module case, baking and drying may be performed. For example, the module case in which the coating layer is formed by the powder coating may be heated to a temperature of 150 to 250° C., for example, 180 to 200° C. After the heating, baking by maintaining the temperature for 5 minutes to 1 hour, for example, 7 minutes to 40 minutes, and drying by indirect hot air or far infrared rays may be further included.

In addition, as necessary, before forming the thermal conductive coating layer, the module case may form a pretreatment layer on a surface of the substrate of the case, and as the pretreatment layer, for example, a chromate layer, a phosphate layer, or the like may be formed.

The battery cell included in the battery module of the disclosure of this patent document is not particularly limited, and may include a positive electrode, a negative electrode, and a separator, recognized in the art.

For example, in a positive electrode, a current collector is not particularly limited, but a thin plate formed of aluminum, stainless steel, or nickel may be used, and it is preferable to use a thin plate formed of aluminum. In addition, a porous body, for example, having a net shape, a mesh shape, or the like, may be used, and an oxidation-resistant metal or an alloy film may be coated to prevent oxidation.

A positive electrode active material may be a compound capable of reversible intercalation and deintercalation of lithium, and may include, specifically, a lithium transition metal complex oxide containing lithium and at least one transition metal of nickel, cobalt, manganese, or aluminum, preferably a lithium transition metal complex oxide containing lithium and transition metals including nickel, cobalt, and manganese.

A binder may be further included to improve binding of an active material and a conductive material, and adhesion to a current collector. Specifically, the binder may include at least one selected from the group consisting of polyvinylidene fluoride, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene terpolymer (EPDM), sulfonated EPDM, a styrene-butadiene rubber, and a fluororubber, preferably polyvinylidene fluoride.

The positive electrode may further include at least one conductive material selected from the group consisting of graphite, a carbon black, a carbon nanotube, a metal powder, and a conductive oxide, to improve conductivity.

In the negative electrode, a negative electrode current collector is not particularly limited as long as it has conductivity without causing chemical change to the battery. For example, those in which a surface of copper, stainless steel, aluminum, nickel, titanium, sintered carbon, copper, or stainless steel is treated with carbon, nickel, titanium, silver, or the like, an aluminum-cadmium alloy, or the like may be used. In addition, like the positive electrode current collector, fine irregularities may be formed on a surface of the negative electrode current collector to enhance a bonding strength of a negative electrode active material, and the negative electrode current collector may be used as various forms such as a film, a sheet, a foil, a net, a porous body, a foam, a nonwoven fabric, or the like.

The negative electrode active material may be a silicon-based negative electrode active material or a carbon-based negative electrode active material. Although not particularly limited, the silicon-based negative electrode active material may use at least one selected from the group consisting of an SiOₓ (0≤x<2) particle, an Si—C composite, and an Si—Y alloy (where Y is an element selected from the group consisting of an alkali metal, an alkaline earth metal, a transition metal, a group 13 element, a group 14 element, a rare earth element, and a combination thereof), and may be, for example, SiO. The carbon-based negative electrode active material, for example, may be at least one selected from the group consisting of an artificial graphite, a natural graphite, and a graphitized mesocarbon microbead, and preferably an artificial graphite.

A negative electrode mixture layer may also include a binder and a conductive material. The binder may include an aqueous binder and a rubber-based binder, and the aqueous binder may be soluble in an aqueous solvent such as water or the like, and may be at least one selected from polyvinyl alcohol (PVA), polyacrylic acid (PAA), polyethylene glycol (PEG), polyacrylonitrile (PAN), polyacrylamide (PAM), and carboxylmethyl cellulose (CMC).

The rubber-based binder may be defined as not being dissolved well in an aqueous solvent such as water or the like, but being smoothly dispersed in the aqueous solvent. Specifically, the rubber-based binder may include at least one selected from a styrene butadiene rubber (SBR), a hydrogenated nitrile butadiene rubber (HNBR), an acrylonitrile butadiene rubber, an acrylic rubber, a butyl rubber, and a fluoro rubber, preferably at least one selected from the group consisting of a styrene butadiene rubber and a hydrogenated nitrile butadiene rubber, in terms of easy dispersion and excellent phase stability, more preferably a styrene-butadiene rubber.

As a conductive material, at least one selected from the group consisting of graphite, a carbon black, a carbon nanotube, a metal powder, and a conductive oxide may be used.

In addition, a porous polymer film, for example, a porous polymer film formed of a polyolefin-based polymer such as an ethylene homopolymer, a propylene homopolymer, an ethylene/butene copolymer, an ethylene/hexene copolymer, an ethylene/methacrylate copolymer, or the like, may be used alone or in a stacked form thereof, or a porous nonwoven fabric, for example, a nonwoven fabric formed of a high melting point glass fiber, a polyethylene terephthalate fiber, or the like may be used, but is not limited thereto.

A secondary battery module may be constructed using the secondary battery as a unit cell, and the one or more modules may be packaged in a pack case to form a secondary battery pack. The secondary battery module and the secondary battery pack including the same, described above, may be applied to various devices. Such devices may be applied to a transportation such as an electric bicycle, an electric vehicle, a hybrid vehicles, or the like, but the disclosure of this patent document is not limited thereto, but may be applied to various devices that may use a secondary battery module and a secondary battery pack including the same, and may also belong to the scope of the disclosure of this patent document.

### EXAMPLE

1. Manufacture of Battery Module

As illustrated in FIG. 1, a coating film was prepared by spraying a powder coating composition in which 70% by weight of a urethane-based resin, 25% by weight of a alumina as an inorganic filler, and 5% by weight of a silica were mixed, on an internal surface of a module case 10 having a lower plate 11 and two side plates 12, formed integrally with aluminum.

In this case, the process was performed by maintaining the module case at a temperature of 45° C. and applying a voltage of 65 KV therein.

Subsequently, the module case on which the coating film was formed was maintained at a temperature of 180° C. for 20 minutes and then baked and dried, to form thermally conductive coating layers 70 having various thicknesses, respectively.

A surface roughness Ra of each of the thermally conductive coating layers 70, formed above, was 1.5 μm.

After accommodating a plurality of battery cells 40 in the internal space of the module case 10 on which each of the thermal conductive coating layers 70 was formed, a connection member 50, an upper cover 60, bus bars 30, and front and rear covers 20 were assembled, respectively, to prepare a battery module 100.

2. Relationships Between Thickness of Coating Layer, Thermal Conductivity, and Withstand Voltage Performance

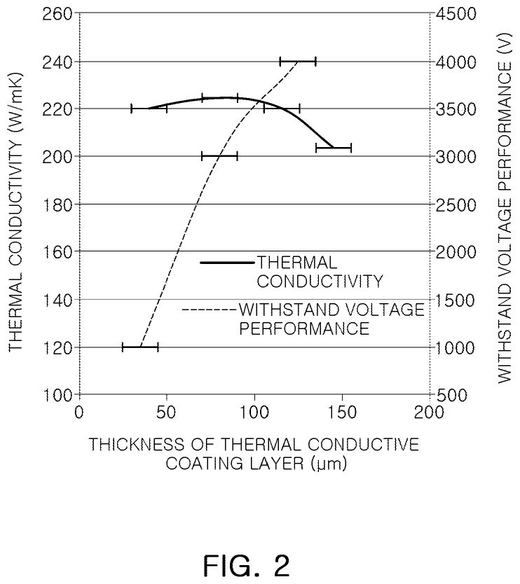

Thermal conductivity and withstand voltage performance according to a thickness applied to the manufactured battery module were evaluated, and results therefrom were illustrated in FIG. 2.

In this case, the withstand voltage performance was measured for modules having thermal conductive coating layers respectively having a thickness of 30 μm±5 μm, a thickness of 80 μm±5 μm, and a thickness of 125 μm±5 μm, and the thermal conductivity was measured for modules having thermal conductive coating layers respectively having a thickness of 30 μm±5 μm, a thickness of 80 μm±5 μm, a thickness of 115 μm±5 μm, and a thickness of 145 μm±5 μm.

In this case, the thermal conductivity was measured using a laser flash method (LFA) apparatus, and the withstand voltage was measured using HIOKI ST5520.

In FIG. 2, it can be seen that as the thicknesses of the thermally conductive coating layers increase, withstand voltage values increased and withstand voltage performance were thus improved. However, it can be seen that thermal conductivity increased until the thicknesses of the thermal conductive coating layers reached about 70 to 90 μm, but then decreased as the thicknesses of the thermal conductive coating layer increased.

In general, a battery module formed of aluminum is evaluated as having excellent performance when the thermal conductivity has a value of 200 W/mK or more, and a withstand voltage value is usually required to have a value of 2500 V or more. It can be confirmed from FIG. 2 that the thermally conductive coating layers having thicknesses of 70 to 150 μm had excellent withstand voltage performance and thermal conductivity at the same time.

According to the disclosure of this patent document, a coating layer having a predetermined thickness in a module case may be formed, to increase a contact area with a battery cell, maintain conductivity and withstand voltage performance in an excellent range, and improve cooling performance, and improvement of adhesion may also be expected.

Only specific examples of implementations of certain embodiments may be described. Variations, improvements and enhancements of the disclosed embodiments and other embodiments may be made based on the disclosure of this patent document.

### DESCRIPTION OF SYMBOLS

10: module case
11: lower plate
12: side plates
20: front and rear covers
30: bus bars
40: battery cells
50: connection member
60: upper cover
70: thermal conductive coating layers
100: battery module

What is claimed is:

1. A battery module comprising:
at least one battery cell;
a module case in which the at least one battery cell is accommodated, and including a lower plate and a side plate forming an internal space; and
a thermally conductive coating layer formed on an internal surface of the lower plate or an internal surface of the lower plate and an internal surface of the side plate, and having a thickness of 70 μm to 130 μm,
wherein the thermally conductive coating layer includes a polymeric binder resin and an inorganic filler.

2. The battery module of claim 1, wherein the thermally conductive coating layer comprises 20 to 50% by weight of the inorganic filler, based on a total weight of the thermally conductive coating layer.

3. The battery module of claim 1, wherein the thermal conductive coating layer has a thermal conductivity of 200 W/mK or more and 230 W/mK or less.

4. The battery module of claim 1, wherein the thermally conductive coating layer has a withstand voltage intensity of 2.5 to 4.0 kV.

5. The battery module of claim 1, wherein adhesive strength between the thermally conductive coating layer and the battery cell is 500 to 2000 gf/10 mm.

6. The battery module of claim 1, wherein the polymeric binder resin comprises at least one selected from the group consisting of an acrylic resin, a urethane-based resin, a silicone-based resin, an epoxy-based resin, and an olefin-based resin.

7. The battery module of claim 1, wherein the inorganic filler comprises at least one ceramic particle selected from the group consisting of alumina, aluminum nitride, boron nitride, silicon nitride, SiC, silica, ZnO, and BeO.

8. The battery module of claim 1, wherein the thermally conductive coating layer further comprises a carbon-based filler.

9. The battery module of claim 1, wherein the thermally conductive coating layer has a surface roughness Ra of 0.7 μm or more and 50 μm or less.

10. A method of preparing a battery module, comprising:
applying a coating composition to an internal surface of a module case including a lower plate and a side plate forming an internal space;
curing the coating composition to form a coating layer having a thickness of 70 μm to 130 μm; and
accommodating at least one battery cell in the module case on which the coating layer is formed.
